(19) United States
(12) Patent Application Publication
(10) Pub. No.: US 2011/0186735 A1
(43) Pub. Date: Aug. 4, 2011

(54) ELECTRON SOURCE, ELECTRON GUN, AND ELECTRON MICROSCOPE DEVICE AND ELECTRON BEAM LITHOGRAPHY DEVICE USING IT

(75) Inventors: Tadashi FUJIEDA, Mito (JP); Makoto Okai, Tokorozawa (JP); Takashi Ohshima, Saitama (JP); Boklae Cho, Hitachinaka (JP)

(73) Assignee: Hitachi, Ltd.

(21) Appl. No.: 13/020,098

(22) Filed: Feb. 3, 2011

(30) Foreign Application Priority Data
Feb. 4, 2010 (JP) 2010-022655

(51) Int. Cl. G21K 7/00; B01J 19/08; H01J 9/04

(52) U.S. Cl. 250/311; 250/492.3; 313/310

(57) ABSTRACT

An electron source is implemented which has a lower work function of an electron emission surface, yields emitted electrons of a narrower energy bandwidth and higher current density, and lasts longer than existing Zr/O/W electron sources. Further, an electron microscope which yields an image of higher-resolution in a shorter time and an electron beam lithography device which yields higher throughput are also provided. The electron source comprises a needle-shaped electrode made of metal having its tip in a needle shape, a heating body which heats up the needle-shaped electrode, and a diffusion source capable of being heated up by the heating body and made of a mixture of barium composite containing oxygen and carbon particles.

### BACKGROUND OF THE INVENTION

The present invention relates to an electron source, an electron gun, and an electron microscope device and an electron beam lithography device using the electron gun.

A Schottky-emission electron source (called herein a “SE electron source”) yields an electron beam of high intensity and stability. It is equipped with a critical dimension scanning electron microscope (CD-SEM), which is used for observation and dimension measurement of micro manufacturing patterns in semiconductor processes, and a high-resolution electron microscope of generic use. In a currently used SE electron source, a single-crystalline tungsten needle of axis orientation of <100>, on which attached is a diffusion source made of zirconium oxide (ZrO₂) (called herein a “ZrO₂ diffusion source” herein), is connected to a tungsten filament. This electron source is designated as “Zr/O/W electron source,” or simply “Zr/O/W” herein. By ohmic-heating of the tungsten filament to about 1800K, the ZrO₂ diffusion source thermally decomposes into zirconium (Zr) and oxygen (O), which diffuse on the surface of the tungsten needle and form Zr—O coating layer on the (100) surface of the tip of the tungsten needle. As a result, the work function of the (100) surface reduces from 4.5 eV to approximately 2.8 eV and a small spot of the (100) surface becomes an electron emission region, which yields an electron beam of higher intensity than conventional thermal electron sources. In addition, this electron source stably operates even in poorer vacuum compared with cold field emission electron sources and thermal flashing for surface cleaning is not needed, which in turn makes continuous operation possible and makes the source easy to use.

Electrons emitted from a source with a narrow energy bandwidth are, on the other hand, necessary for improvement of resolution in electron-beam application devices. The aforementioned Zr/O/W yields energy bandwidths of about 0.4 eV at Schottky emission region, where the bandwidth is typically narrow. Since the Schottky emission electrons are thermally induced, in order to make the energy bandwidth narrower, lower operating temperatures are necessary. Lower operating temperatures, however, reduce emission currents and decrease of work function becomes needed to compensate the effect.

JP-A-11-224629 discloses diffusion sources made of a compound of alkali metal or alkali earth metal containing oxygen with an addition of one of the following material as a reducing agent: one of the elements of atomic numbers of 3 through 6, 11 through 16, 19 through 34, 37 through 53, 55 through 84, or 88 through 94, a compound which includes the above elements, or a mixture of two or more elements/compounds. More specifically, embodiments of diffusion sources are disclosed which are a mixture of barium carbonate (BaCO₃), calcium carbonate (CaCO₃), strontium carbonate (SrCO₃), and aluminum powder as a reducing agent. It is disclosed that the source operates at a low temperature of approximately 1000K emitting electrons of narrower energy bandwidth than the aforementioned Zr/O/W. It also yields electron densities per emission solid angle of 100 times higher than the Zr/O/W. There is a weakness, however, that the electron emission continues only for a few hours at the operating temperature of about 1000K and the source needs to be re-heated to 1500K or higher for further operation. It is known that barium oxide (BaO) itself is difficult to diffuse while metallic barium (Ba) is easy to diffuse. Short operation at about 1000K is due to insufficient thermal decomposition of BaO, which results in insufficient production of Ba and O as absorbents.

### SUMMARY OF THE INVENTION

The purpose of the present invention is to provide an electron source which has a lower work function of an electron emission surface, yields emitted electrons of a narrower energy bandwidth and higher current density, and lasts longer than existing Zr/O/W electron sources.

After diligent investigations to achieve the aforementioned purpose, in an electron source comprising a needle-shaped electrode made of metal having its tip in a needle shape and a heating body which heats up the needle-shaped electrode, the present inventers created a diffusion source capable of being heated up by the heating body, wherein the diffusion source is made of a mixture of barium composite containing oxygen and carbon particles. It was found that electron emission of narrow energy bandwidths and high current densities can be obtained at an operating temperature of 1000K to 1200K for a long time.

The aforementioned carbon particles preferably comprise at least one of fullerenes, carbon nanotubes, graphite particles, and carbon black.

According to the present invention, an electron source can be provided which has a lower work function of an electron emission surface, yields emitted electrons of a narrower energy bandwidth and higher current density, and lasts longer than existing Zr/O/W electron sources. Also, according to the present invention, an electron gun, an electron microscope device, and an electron beam lithography device using the electron source can be provided.

Other objects, features and advantages of the invention will become apparent from the following description of the embodiments of the invention taken in conjunction with the accompanying drawings.

### BRIEF DESCRIPTION OF THE DRAWINGS

FIGS. 1A, 1B, and 1C, are diagrams illustrating a first embodiment of the present invention, where FIG. 1A is a diagram schematically showing an electron source of the present invention arranged with a suppressor electrode, FIG. 1B is a diagram schematically showing a tip of the needle-shaped electrode, and FIG. 1C is a diagram schematically showing an electron source of the present invention arranged with a suppressor electrode, in which a longer life of the diffusion source is intended;

FIG. 2 is a diagram schematically showing an electron gun of the present invention;

FIG. 3 is a diagram schematically showing a scanning electron microscope equipped with an electron gun of the present invention; and

FIG. 4 is a diagram schematically showing an electron beam lithography device equipped with an electron gun of the present invention.

### DESCRIPTION OF THE EMBODIMENTS

Hereinafter, the present invention is described in detail. The present invention is, however, not limited to the embodiments described herein.

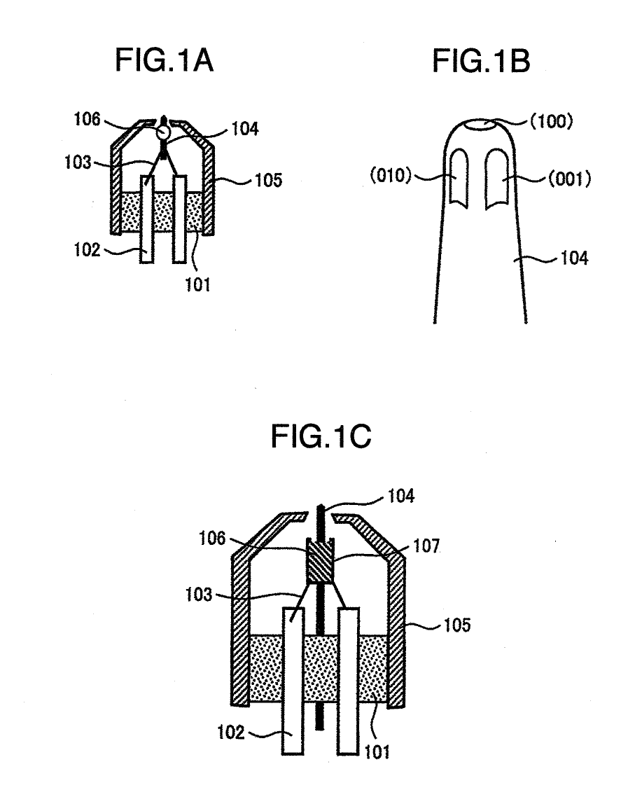

A first embodiment of the present invention is explained referring to FIGS. 1A, 1B, and 1C.

A heater body 103 was connected by spot-welding to electric terminals 102, which were brazed to a glass insulator 101. The heater body was made of a tungsten (W) filament of a cross-section diameter of 0.127 mm configured in a V-shape. At the apex of the W filament, then, a W <100>single crystal of a cross-section diameter of 0.127 mm was spot-welded with its longitudinal direction aligned with crystalline orientation of <100>. A tip of the single crystal was sharpened to a curvature radius of about 1 μm by electro-polishing to form a needle-shaped electrode 104. In addition, a suppressor electrode 105 was configured to prevent emission of thermal electrons from surfaces other than the tip of the needle-shaped electrode. Next, barium carbonate (BaCO₃) particles of the average diameter of a few μm were mixed with graphite particles, as reducing agents, of the average diameter of 0.1 μm to 1 μm at a 1:1 molar ratio in an organic solvent containing ethylcellulose. After the mixture was homogenized using sonication, the organic solvent was partly vaporized to make the mixture into a paste; the paste was applied to the middle of the needle-shaped electrode 104 as a diffusion source 106.

It is preferable to adopt a structure as shown in FIG. 1C that the diffusion source 106 is covered by a tube 107 made of metal such as tungsten, tantalum, niobium, and stainless steel in order to impede vaporization of barium resulted from decomposition of barium carbonate so that a life of the diffusion source is intended to be elongated. In such a structure, it is preferable that the needle-shaped electrode 104 is brazed to the glass insulator 101 to support the diffusion source.

Then, the W filament was ohmicly-heated in a vacuum of 10⁻⁶ Pa range to heat up the needle-shaped electrode to about 600K, so that water and organic compounds in the aforementioned diffusion source were vaporized.

After that, the W filament was further ohmicly-heated in a vacuum of 10⁻⁷ Pa range to heat up the needle-shaped electrode to about 1100K. At this condition, a fluorescent screen was placed facing the needle-shaped electrode to observe a field emission pattern; while the screen was grounded, a negative extraction voltage was applied to the needle-shaped electrode. Moreover, a negative voltage of a few hundred volts with respect to the needle-shaped electrode was applied to the suppressor electrode configured to prevent emission of thermal electrons from surfaces other than the tip of the needle-shaped electrode.

After a while, an emission current gradually increased and a high-intensity electron emission pattern showed up on the axis of electron emission. This was due to the fact that BaCO₃ was reduced by graphite particles at 1100K to separate Ba and O, which diffused to the tip of the needle-shaped electrode and adhered preferentially on the (100) surface at the center of the tip shown in FIG. 1B, and, consequently, the work function decreased locally. It was also confirmed that this state continues at least more than 1000 hours. Furthermore, a current density per emission solid angle was measured using a Faraday cup positioned behind the fluorescent screen. As a result, a current density per emission solid angle of about 100 times greater than the one measured with a Zr/W/O electron source at the same condition was obtained.

For comparison, diffusion sources were made by adding any one of Si, Ti, and Al powders at a 1:1 molar ratio to BaCO₃ and evaluated. Si, Ti, and Al have thermodynamically stronger reducing strength than carbon. The result revealed that these diffusion sources yielded the same current density per emission solid angle as that of the diffusion source made of a mixture of BaCO₃ and graphite particles at a temperature lower by about 100K. The emission currents, however, gradually decreased and were not stable. It is presumed that oxides of Si, Ti, and Al were formed and hindered diffusion of Ba.

As barium composites containing oxygen, the following can be used other than BaCO₃:BaO, Ba(OH)₂, multiple oxides such as BaAlₓO_{y} (x<y), or, further, a mixture made by adding carbonates of elements other than Ba such as SrCO₃ and CaCO₃ to BaCO₃.

As reducing agents for barium composites containing oxygen, carbon particles which are electrically conductive and comprise graphite such as fullerenes, carbon nanotubes, and carbon black are also preferable besides graphite particles. It is also preferable that the diameters of the carbon particles are smaller than those of barium composite particles containing oxygen from the following reason. When the carbon particles have greater diameters than the barium composite particles, contact areas between barium composite particles and carbon particles become smaller compared with those when the carbon particles have smaller diameters supposing that the ratio of addition of the carbon particles to the barium composite particles is the same. Consequently, the efficiency of reducing reaction becomes lower and barium composites not in contact with the carbon particles remain in tact without being reduced, which ends up in a shorter life of the diffusion source accordingly.

It is preferable that the ratio of carbon as a reducing agent to the barium composites containing oxygen is in the range of 0.1:1 to 2.0:1 molar ratio. When the ratio is lower than 0.1:1 molar ratio, there exist barium composite particles not in touch with carbon particles and they remain in tact without being reduced. When the ratio is greater than 2.0:1 molar ratio, there exist carbon particles not contributing to the reduction process and an amount of BaCO₃ decreases accordingly. Consequently, a life of the diffusion source becomes shorter.

Prior to electron emission, a positive bias was applied to the needle-shaped electrode and the tip of the needle was cleaned by field evaporation by removing substances attached on the surface of the needle-shaped electrode, which hinder diffusion of Ba and O separated from the diffusion source to the tip of the needle-shaped electrode. Compared with the case when no such cleaning was conducted, emission currents stabilized in shorter times. Moreover, during general thermal flashing at 1800K or higher, there is a shortcoming that barium composites in the diffusion source would be lost.

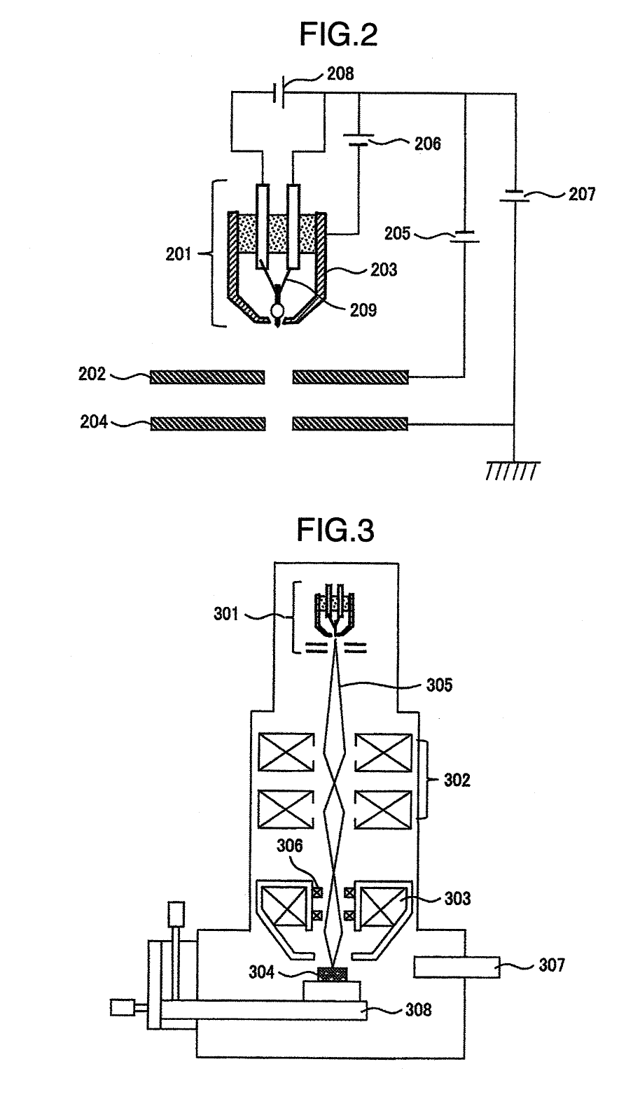

A second embodiment of the present invention is explained referring to FIG. 2. FIG. 2 is a diagram schematically showing an electron gun associated with the present invention.

An electron gun of the present invention comprises the electron source 201 described in the first embodiment, an extract electrode 202 to emit electrons from the needle-shaped electrode, a suppressor electrode 203 to prevent emission of thermal electrons from surfaces other than the tip of the needle-shaped electrode, an acceleration electrode 204 to accelerate the electrons emitted from the needle-shaped electrode, and a heater power supply 208 for ohmic-heating of the heater body 209 comprising the W filament. A positive voltage with respect to the needle-shaped electrode is applied to the extract electrode using an extract electrode power supply 205. A negative voltage with respect to the needle-shaped electrode is applied to the suppressor electrode using a bias power supply 206. Also, a positive voltage with respect to the needle-shaped electrode is applied to the acceleration electrode using an acceleration electrode power supply 207. Moreover, a negative voltage with respect to the needle-shaped electrode is applied only to the extract electrode when substances attached on the surface of the needle-shaped electrode are removed prior to electron emission.

Accordingly, stable emission currents can be obtained for a long time from the electron gun with narrow energy bandwidths and high current densities.

A third embodiment of the present invention is explained referring to FIG. 3.

FIG. 3 is a diagram schematically showing a structure of a scanning electron microscope equipped with an electron gun of the present invention. An electron beam emitted from an electron gun 301 is focused on a sample 304 positioned on a sample stage 308; the focusing is achieved by electro-optical parts and the like represented mainly by condenser lenses 302 and an objective lens 303. Moreover, trajectories of electrons 305 are also shown simultaneously in the figure. While the focal point is scanned using a deflector 306, secondary electrons are detected with an electron detector 307 and conversion to electrical signals yields a SEM image.

Installation of an electron gun of the present invention implements a scanning electron microscope which yields an electron microscope image of higher-resolution in a shorter time and operates more consistently for a longer time compared to conventional devices. A critical dimension scanning electron microscope (CD-SEM), which is used for observation and dimension measurement of micro manufacturing patterns in semiconductor processes, has a similar structure as shown in FIG. 3. Therefore, installation of the electron gun 301 yields similar effects in a CD-SEM.

Here, the embodiment of the present invention is explained using the diagram of the structure of the scanning electron microscope illustrated in FIG. 3 as an electron microscope device equipped with an electron gun of the present invention. The present invention is, however, not limited to this exact structure and applicable to devices of any structures as long as they sufficiently utilize features of the electron gun of the present invention.

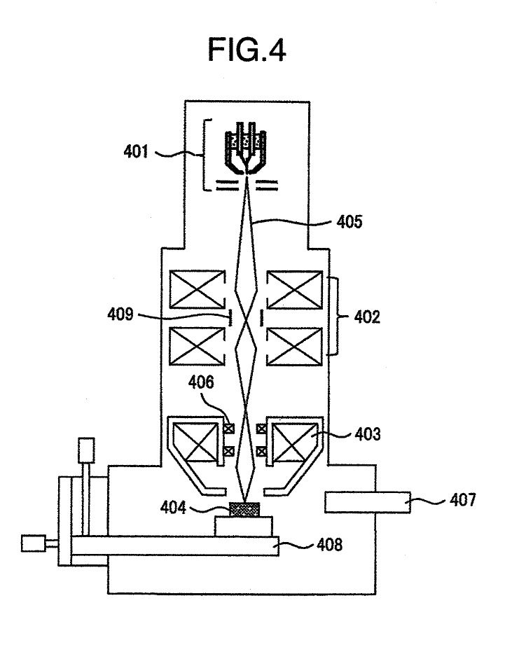

A fourth embodiment of the present invention is explained referring to FIG. 4.

FIG. 4 is a diagram schematically showing an electron beam lithography device equipped with an electron gun of the present invention.

The electron beam lithography device has a similar structure to the scanning electron microscope shown in FIG. 3 except being equipped with a blanker 409 between condenser lenses 402 in order to turn the electron beam on and off. In other words, an electron beam emitted from an electron gun 401 is focused on a sample 404 placed on a sample stage 408; the focusing is achieved by electro-optical parts and the like represented mainly by the condenser lenses 402 and an objective lens 403. In the figure, trajectories of electrons 405 are also shown. The focal point is scanned using a deflector 406 and secondary electrons are detected with an electron detector 407. The electron beam lithography device irradiates a finely focused electron beam on the sample 404, on which an electron-beam resist sensitive to electron beams is coated, to form micro patterns.

By installing the electron gun 401 of the present invention, more detailed patterns can be drawn at improved drawing speeds compared to using conventional devices.

It should be further understood by those skilled in the art that although the foregoing description has been made on embodiments of the invention, the invention is not limited thereto and various changes and modifications may be made without departing from the spirit of the invention and the scope of the appended claims.

1. An electron source comprising:
a needle-shaped electrode made of metal having its tip in a needle shape;
a heating body which heats up said needle-shaped electrode; and
a diffusion source capable of being heated up by said heating body, wherein said diffusion source is made of a mixture of barium composite containing oxygen and carbon particles.

2. The electron source of claim 1, wherein said carbon particles comprising at least one of fullerenes, carbon nanotubes, graphite particles, and carbon black.

3. The electron source of claim 1, wherein a ratio of said carbon to said barium composites containing oxygen in said diffusion source is in the range of 0.1:1 to 2.0:1 molar ratio.

4. An electron gun comprising:
said electron source of claim 1;
a suppressor electrode to prevent emission of thermal electrons from surfaces other than said tip of said needle-shaped electrode in said electron source;
an extract electrode to emit electrons from said electron source; and
an acceleration electrode to accelerate said electrons emitted from said electron source.

5. An electron microscope device, in which an electron beam emitted from said electron gun of claim 4 is irradiated on a sample so that said sample is observed.

6. An electron beam lithography device, in which an electron beam emitted from said electron gun of claim 4 is irradiated on a sample so that electron-beam lithography is conducted on said sample.

7. A method of operating the electron source of claim 1 which comprises:
a step of applying a positive voltage to said needle-shaped electrode to clean the surface of said needle-shaped tip; and
a step of emitting electrons from said electron source after said step of applying the positive voltage.

8. The method of claim 7, wherein said needle-shaped electrode is heated up to a temperature between 1000K and 1200K in said step of emitting electrons from said electron source.
